(19) United States
(12) Patent Application Publication
(10) Pub. No.: US 2002/0090329 A1
(43) Pub. Date: Jul. 11, 2002

(54) Apparatus for a fuel processing system

(76) Inventor: Marten Ternan, Ottawa (CA)

Correspondence Address: FULBRIGHT & JAWORSKI, LLP, 666 FIFTH AVE, NEW YORK, NY, 10103-3198, US

(21) Appl. No.: 09/918,707

(22) Filed: Jul. 31, 2001

Related U.S. Application Data
(60) Provisional application No. 60/224,673, filed on Aug. 11, 2000.

(51) Int. Cl. B01L 7/00; B01J 8/02

(52) U.S. Cl. 422/198; 422/211; 422/199; 422/197; 422/196; 422/201; 48/61; 48/127.9

(57) ABSTRACT

A fuel processor including a hydrogen generating apparatus, a single vessel heat-integrated multi-stage water-gas shift reactor, a multifunctional heat exchanger, a multiple heat source boiler, and a single vessel water exchanged multi-staged preferential oxidation reactor is integrated with a fuel cell stack. Hydrogen is manufactured by the fuel processing apparatus and is consumed by the fuel cell stack, thereby providing one means of integration. The portion of the hydrogen that is not utilized within the fuel cell stack is subsequently burned in the combustion chamber of the fuel processing apparatus thereby providing a second means of integration. The warm cooling water that exits from the fuel cell stack is used as a heat sink for the exothermic heat of reaction in the preferential oxidation reactor, thereby providing a third means of integration.

### BACKGROUND TO THE TECHNOLOGY

1. Field

The present invention relates to new apparatuses useful for the conversion by steam reforming of hydrocarbons and fossil fuels into hydrogen that is the feedstock for fuel cell stacks that generate electricity. Still more particularly, the present invention is concerned with particular equipment, a hydrocarbon generating apparatus, a single vessel heat integrated multi-stage water-gas shift reactor, a multiple heat source boiler, a multi-functional heat exchanger, and a multi-staged preferential oxidation reactor, and the combination thereof into a fuel processor. The present invention is further related to the integration of said fuel processor with a fuel cell stack.

2. Description of the prior art

Distributed electrical power systems for residences can be realized by the combination and integration of various equipment. This invention relates to improvements in specific fuel processing equipment used to produce hydrogen for a fuel cell stack and more particular to the synergies that can be obtained from specific methods of combination and integration of said fuel cell stack operating on hydrogen with said fuel processing equipment that produces the required hydrogen, to form systems that are suitable for residential distributed power generation.

However means of improving fuel processing apparatuses are continually being sought, and as a consequence many patents have issued in this area.

U.S. Pat. No. 4,847,051 claims a fuel processor in a fuel cell power plant. It describes the advantages of sleeves about the individual catalyst tubes within the reformer. It does not suggest any particular technique for combining the reformer with the fuel cell.

U.S. Pat. No. 4,650,727 discloses a fuel cell power system combining a fuel cell and a fuel processing apparatus that operates on an organic fuel such as methanol using a fuel conversion catalyst specifically identified as a partially reduced copper oxide and zinc oxide solid. Although this catalyst has frequently been used for methanol conversion, it is well known that other catalysts are superior to it far steam reforming fuel feed stocks other than methanol. Since systems to distribute methanol to residences are not generally available whereas distribution systems are in place for fuels such as natural gas and liquefied petroleum gas, methanol is unlikely to be a fuel for residential power generation.

U.S. Pat. No. 5,985,474 discloses a combination of a fuel cell and a furnace that are heated with a hydrogen containing reformate produced by a fuel processor or reformer, in order to provide both electricity and heat to a residence. Although it is essential to use a hydrogen containing feedstock as the fuel for the fuel cell, there are other possibilities for the fuel used in furnaces. It is much more efficient to use a fuel such as natural gas or liquefied petroleum gas directly in a furnace than to use energy to convert that fuel to a hydrogen containing reformate and subsequently burn the hydrogen containing reformate in the furnace.

U.S. Pat. No. 5,401,589 discloses a combination of a fuel cell and a reformer to generate electrical power. For example, waste gases were fed to a turbine to generate electricity. The various components in the systems functioned independently of one another. Any integration of the fuel cell with the fuel processor was limited.

It is the object of the present invention to provide an improved fuel processing apparatus comprised of a hydrogen generating apparatus, a single vessel heat integrated multi-stage water-gas shift reactor, a multifunctional heat exchanger, a multiple source boiler, and a single vessel water heat exchanged multi-staged preferential oxidation reactor, that when combined to form a fuel processing apparatus satisfy the criteria of compact size for residential application, short start-up times that are consistent with residential needs, rapid responses to transient changes in demand for electricity, and maximum energy efficiency. It is a further object of the present invention to integrate a fuel cell stack with the said fuel processing apparatus by multiple means.

It is a further object of the present invention to provide various embodiments of a fuel processor apparatus having the aforesaid characteristics, including methods of further improvement by operating the fuel processing apparatus with a fuel cell stack in a manner whereby integration is performed by more that one means simultaneously to achieve various advantageous results.

The present invention will be best understood, and further objects and advantages thereof will be apparent, from the following description when read in connection with the accompanying drawings.

### SUMMARY OF THE INVENTION

Improvements over the prior art are provided according to the present invention by first improving each major equipment sub-system of the fuel processor. According to the present invention the hydrogen generating apparatus is equipped with a side mounted metal fiber burner that operates in a blue flame mode that is located just above the burner surface producing heat in a convective way. The single vessel heat-integrated multi-stage water-gas shift reactors combine two or more water-gas shift reactors within a single vessel having means of communicating with a multi-functional heat exchanger that decreases the temperature of the process gas from the high temperature shift reactor to a desired value while simultaneously transferring the unwanted heat to water that is recirculated to a boiler for the generation of steam. The multi-functional heat exchanger not only transfers heat from the process gas from the high temperature water gas shift reactor, it also contains an immersion electrical heater that can transfer heat via recirculated water to produce steam. The immersion water heater is particularly important for rapid start-up when the system has not been used for an extended period. The multiple heat source boiler obtains heat from the process gas from the high temperature water-gas reactor and from the electrical immersion heater as described above. In addition heat is received from the process gas from the low temperature shift reactor and from the combustion gas mixture from the combustion chamber. The single vessel water exchanged multi-stage preferential oxidation reactor is divided into at least two stages. Make-up air is added to each of the stages, thereby providing an improved distribution of air and ensuring that not all the air is used in the first part of the reactor. Each preferential oxidation reactor stage has a particular shell and tube design. In one embodiment of the present invention, warm cooling water exiting from the fuel cell stack is used on the shell side. It acts as a sink for the exothermic heat of reaction from the preferential oxidation reaction that must be managed in the first stage of the preferential oxidation reaction. It also provides a controlled temperature to ensure that an adequate rate of preferential oxidation is maintained and that the small quantities of carbon monoxide that enter the second stage are converted to obtain the 10 ppm carbon monoxide specification.

Another aspect of the present invention provides for the integration of the fuel processing apparatus with a fuel cell stack through more than one means simultaneously. As described above a first means of integrating the fuel processor with the fuel cell is through the warm cooling water exiting from said fuel cell stack that is subsequently used on a shell side of the preferential oxidation reactor. A second means of integrating the two apparatuses is by routing the anode off-gas containing un-reacted hydrogen from said fuel cell stack to the hydrogen generating apparatus within said fuel processing apparatus for burning inside the combustion chamber. A third means of integrating the two apparatuses is through the supply stream of the hydrogen containing product process gas that is made by said fuel processing apparatus and consumed by said fuel cell stack.

### BRIEF DESCRIPTION OF DRAWINGS

FIG. 1 is a process flow diagram illustrating the apparatus and flow paths of the fuel processing apparatus according to the present invention.

FIG. 2 is a diagram illustrating one preferred embodiment of the hydrogen generation apparatus including a combustion chamber, a burner, a steam reformer catalytic reactor, and a heat exchanger.

FIG. 3 is a diagram illustrating one preferred embodiment of the single vessel heat-integrated multi-stage water-gas shift reactor.

FIG. 4 is a diagram illustrating one preferred embodiment of the multiple heat source boiler.

FIG. 5 is a diagram illustrating one preferred embodiment of the multi-function heat exchanger.

FIG. 6 is a diagram illustrating one preferred embodiment of the single vessel water heat exchanged multi-staged preferential oxidation reactor.

### DETAILED DESCRIPTION OF THE INVENTION:

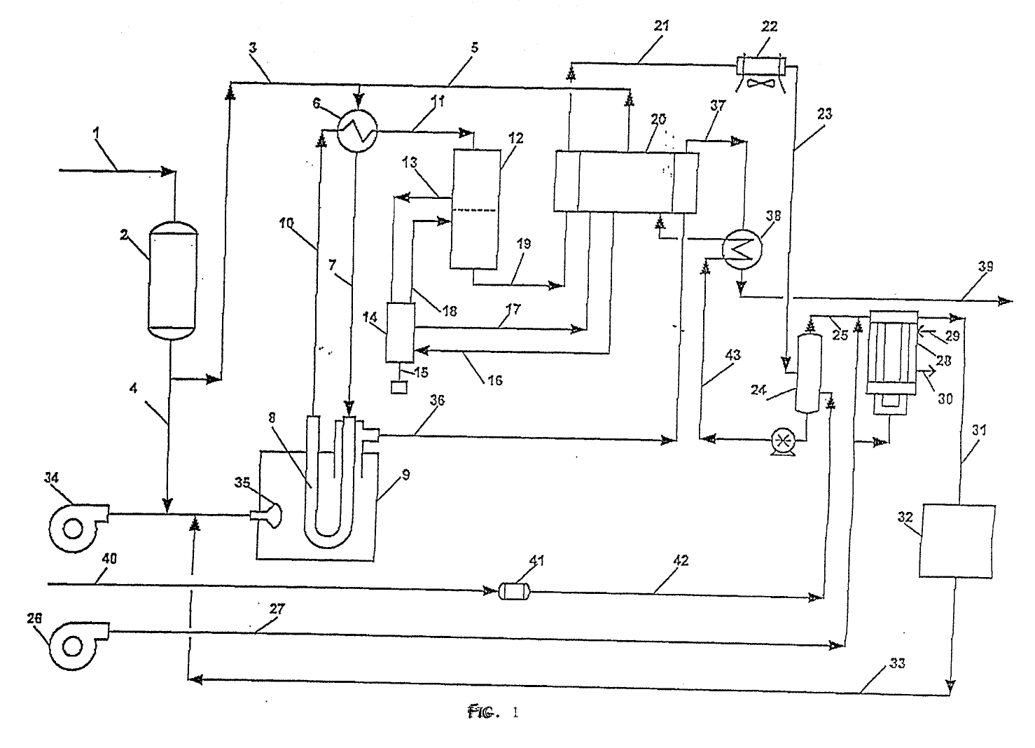

The apparatus and equipment for generating a hydrogen-containing gas of the quality necessary for sustained operation of a polymer electrolyte fuel cell stack is illustrated in FIG. 1, which is one embodiment of the present invention. A hydrocarbon feedstock or fossil fuel, such as natural gas, liquefied petroleum gas, diesel fuel, 1 is passed through a fixed bed of adsorbent 2, preferably an activated carbon adsorbent or an activated carbon adsorbent impregnated with copper, wherein odorants such as mercaptans or hydrothiophenes are adsorbed to produce a hydrocarbon feedstock that is almost sulfur free, having a sulfur content less than the specification of the catalysts used to within the fuel processing apparatus to produce a hydrogen-containing gas mixture. A portion of the desulfurized hydrocarbon 3 is mixed with steam 5 to become the steam reformer catalytic reactor feedstock mixture. Another portion of the desulfurized hydrocarbon 4 is mixed with other gases and used as a combustion fuel. The steam reformer catalytic reactor feedstock mixture is heated in the feedstock pre-heat exchanger 6 by heat transferred from the steam reformer catalytic reactor product gases, 10 to become the heated steam reformer catalytic reactor gas feedstock, 7. The feedstock 7 is reacted via the steam reforming reaction to form a reformate product gas mixture, 10 comprised of carbon monoxide, hydrogen, and other gases after passing through a fixed bed of steam reforming catalyst contained in the U-tube shaped steam reformer catalytic reaction vessel, 8 that is part of the hydrogen generating apparatus, 9. A suitable steam reforming catalyst is commercially available as G-91 from Sud-Chemie. After passing through the pre-heat exchanger 6 and being cooled the cooled steam reformer catalytic reactor product gas mixture 11 enters the fixed bed of high temperature water-gas shift catalyst contained within the single vessel heat integrated multi-stage water-gas shift reactor, 12. A suitable high temperature water-gas catalyst is available commercially as G-3 C from Sud-Chemie. The product gas mixture from the fixed bed of high temperature water-gas shift catalyst, 13 flows through multi-functional heat exchanger 14 where its temperature is decreased and it becomes the feedstock 18 to the fixed bed of low temperature water-gas shift catalyst contained within the single vessel heat integrated multi-stage water-gas shift reactor, 12. A suitable low temperature water-gas shift catalyst is available commercially as C 18-8 from Sud-Chemie. The water-gas shift reaction of carbon monoxide with water to form an additional quantity of hydrogen plus carbon dioxide occurs within the single vessel heat integrated multi-stage water-gas shift catalysts. The product process gas from the single vessel heat integrated multi-stage water-gas shift reactor 19 flows through the inside of some of the tubes within the multiple heat source boiler 20 where the heat it transfers to the water within the multiple heat source boiler is some of the heat necessary to generate the amount of steam required for steam reforming reaction. The cooled product process gas from the multiple heat source boiler 21 passes through an air cooled heat exchanger 22 to decrease its temperature below its dew point and thereby to condense some of its water to form a vapor/liquid phase mixture, 23.

The mixture passes into a separator vessel 24 to form a vapor stream 25 and a liquid water stream 43. The vapor stream 24 is mixed with some of the air 27 from an air blower 26 and enters the first catalyst stage of a single vessel water heat exchanged multi-staged preferential oxidation reactor 28. After the first stage within the single vessel water heat exchanged multi-stage preferential oxidation reactor 28, the product process gas is mixed with the balance of air 27 from the air blower 26 and is passed through a second catalyst stage within the single vessel water-heated multi-stage preferential oxidation reactor 28. The temperature of the catalyst stages within the single vessel water heat exchanged multi-stage preferential oxidation reactor is maintained by circulating a water stream such as the cooling water from the fuel cell stack. The product process gas from the single vessel water heat exchanged multi-stage preferential oxidation reactor 31 is the hydrogen containing feedstock gas for the fuel cell stack 32. A portion of the hydrogen in the fuel cell stack feedstock 31 is consumed in the fuel cell stack. The portion of hydrogen that is not consumed remains in the anode off gas 33 from the fuel cell stack that is used as one of the fuels that are burned in the combustion chamber of the hydrogen generating apparatus 9 to supply the endothermic heat of the steam reforming reaction. The combustion product gas 36 from the hydrogen generating apparatus flows through the inside of some of the tubes in the multiple heat source boiler where the heat that is transferred to the water is some of the heat necessary to generate the steam 5 required for the hydrogen generating apparatus. The combustion product gas 37 leaving boiler 20 transfers some of its heat in heat exchanger 38 to the boiler feed water 43 that enters boiler 20. Domestic water 40 is treated by chlorine removal and ion exchange in a water treatment cartridge 41 to produce make-up water 42 that initially flows into the bottom of separator 24 and ultimately into boiler 20.

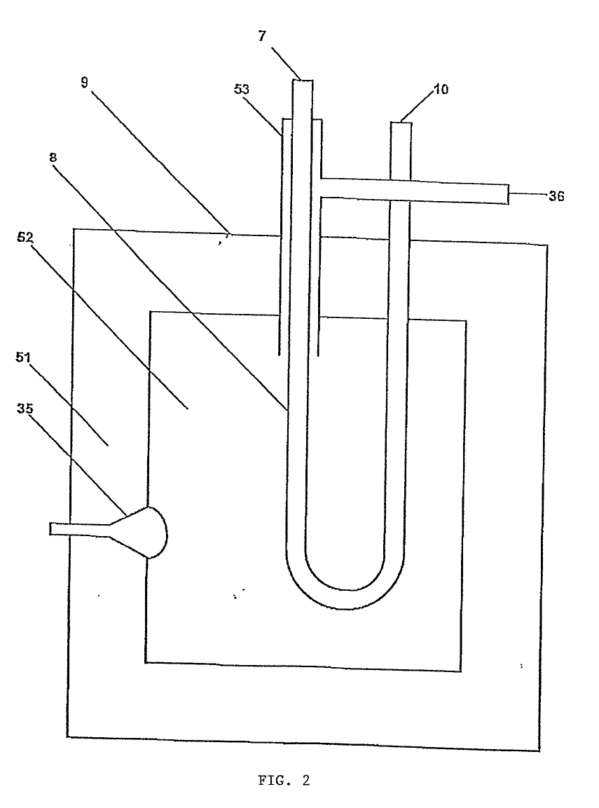

The components of the equipment used in the hydrogen generating apparatus, including a combustion chamber, a burner, a steam reformer catalytic reactor, and a heat exchanger are illustrated in FIG. 2, which is one embodiment of the present invention. The hydrogen generating apparatus 9 is composed of a combustion chamber 52 that is surrounded by insulation 51, a burner 35, a U-tube shaped steam reforming catalytic reaction vessel 8, and a double pipe heat exchanger 53. The mixture of hydrocarbon and steam enter U-tube shaped steam reforming catalytic reaction vessel 8 through means 7 and are heated in double pipe heat exchanger 53, pass through a fixed bed of steam reforming catalyst where the hydrocarbon and steam are converted to carbon monoxide and water. The steam reformer product gases exit the U-tube shaped steam reforming reactor vessel through means 10. The endothermic heat required by the steam reforming reaction is provided by heat delivered from burner 35 by burning a mixture of hydrocarbon, anode off-gas, and air in combustion chamber 52. The mixture of combustion gas products passes through double pipe heat exchanger 52, transferring heat to the incoming mixture of hydrocarbon and steam and subsequently exits through means 36.

### DESCRIPTION OF THE PREFERRED EMBODIMENT

In a preferred embodiment, the combustion chamber 52 has an internal diameter of 12 inches and an internal length of 18 inches. Each side of the U-tube shaped steam reforming reaction vessel has a length of 23 inches, measured from the exterior of the hydrogen generating apparatus 9 to the point of maximum radius of the U portion of the U-tube. The U-tube shaped steam-reforming vessel is fabricated from a 2 inch 310 stainless steel schedule 40 pipe. A thickness of 5 inches of insulation surrounds the combustion chamber. The outer pipe of the double pipe heat exchanger is fabricated from 3 inch 304 stainless steel tubing having a 1/8 inch wall thickness. The burner is a conical shaped burner commercially available from Acotech.

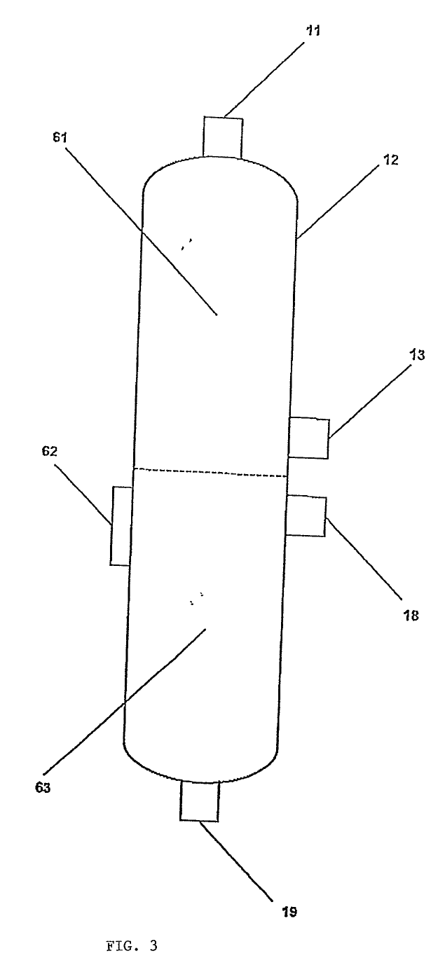

The equipment used in the single vessel heat integrated multi-stage water-gas shift reactor, including two water gas shift reactors, and a means of exchanging heat with a multi-functional heat exchanger are illustrated in FIG. 3, which is one embodiment of the present invention. The reformer product gas mixture enters the single vessel heat integrated multi-stage water-gas shift reactor 12 through inlet means 11 and passes through the fixed bed of high temperature water-gas shift catalyst 61, and exits through exit means 13 to pass to the multi-functional heat exchanger and return through entrance means 18 to flow through the fixed bed of low temperature water-gas shift catalyst 63 and exit through exit means 19. Port 62 of the single vessel heat integrated multi-stage water-gas shift reactor 12 is used to replace the low temperature water-gas shift catalyst 63 when required.

Description of the Preferred Embodiment

In a preferred embodiment, the water-gas shift reaction vessel was fabricated from 4 inch 304 stainless steel schedule 40 piping. The length of the vessel was 28 inches. The inlet to the fixed bed of high temperature water-gas shift catalyst was located at the upper end of the vessel. A solid bulkhead plate was welded to form a gas tight seal at the center of the vessel. An outlet from the fixed bed of high temperature water-gas shift catalyst fabricated from 1/2 inch 304 stainless steel piping was centered 1¼ inches above the center line of the vessel. An inlet to the fixed bed of low temperature water-gas shift catalyst fabricated from 1/2 inch 304 stainless steel piping was centered 1½ inches below the center line of the vessel. The outlet from the fixed bed of low temperature water-gas shift catalyst was located at the bottom end of the vessel.

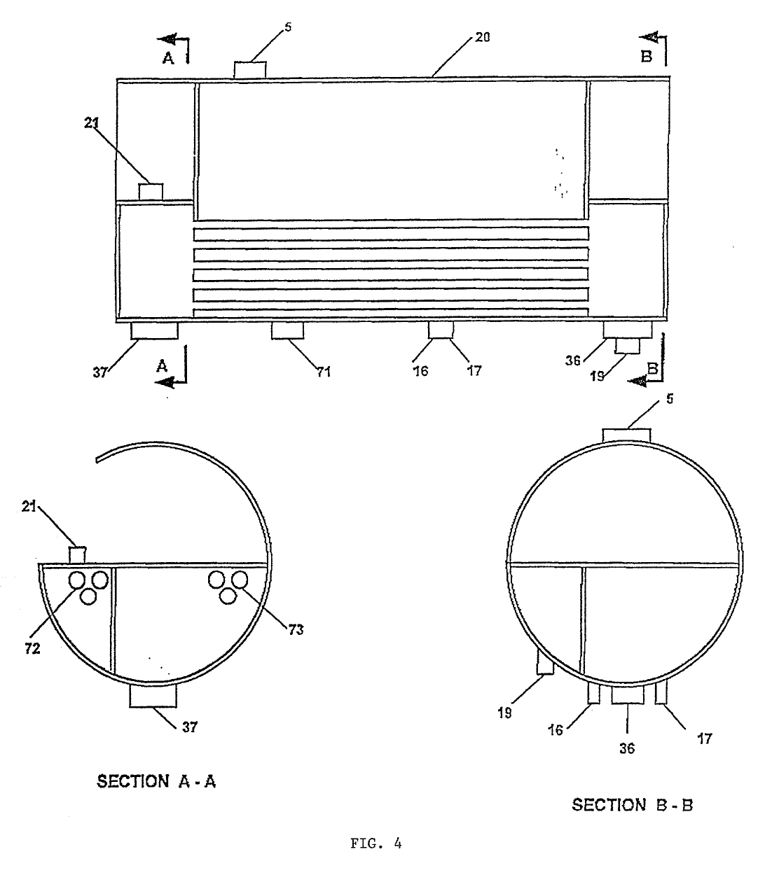

The equipment used in the multiple heat source boiler, including a means of exchanging heat with a multi-functional heat exchanger, a means of receiving heat from the multi-functional heat exchanger, and a means of exchanger heat with the single vessel heat integrated multi-stage water-gas shift reactor are illustrated in FIG. 4, which is one embodiment of the present invention. Boiler feed water enters the multiple heat source boiler through inlet means 71, receives heat to change its phase into steam and exits through exit means 5. Heat is provided to the multiple heat source boiler 20 by the product process gas from the single vessel heat integrated multi-stage water-gas shift reactor 19 which flows through a first bank of 10 tubes 72 and exits through exit means 21. A second means of receiving heat is from the combustion product gas from the combustion chamber 36 that flows through a second bank of 42 heat exchange tubes 73 and exits through exit means 37. The third means of providing heat to the multiple heat source boiler, 20 is by re-circulating water 16 from boiler 20 to the multi-functional heat exchanger and receiving this stream returned in the form of a water-vapor mixture through inlet means 17.

Description of the Preferred Embodiment

In a preferred embodiment the multiple heat source boiler was a unique shell and tube heat exchanger fabricated from 10 inch 304 stainless steel piping. It had a length of 19 inches. A partial tube sheet was located 2½ inches from the end of the boiler at which the combustion gas mixture entered. Another partial tube sheet was located 3 inches from the end at which it exited. The headspace at each end where gases entered and exited various tubes was divided into two different sections. One of the sections contained 10 tubes through which the process gas flowed. The other headspace section contained 42 tubes through which the combustion gas mixture flowed. All of the tubes were 1/2 inch 304 stainless steel set on ⅝ inch triangular pitch. The space on the exterior of the tubes was filled with the water that was being heated to form steam.

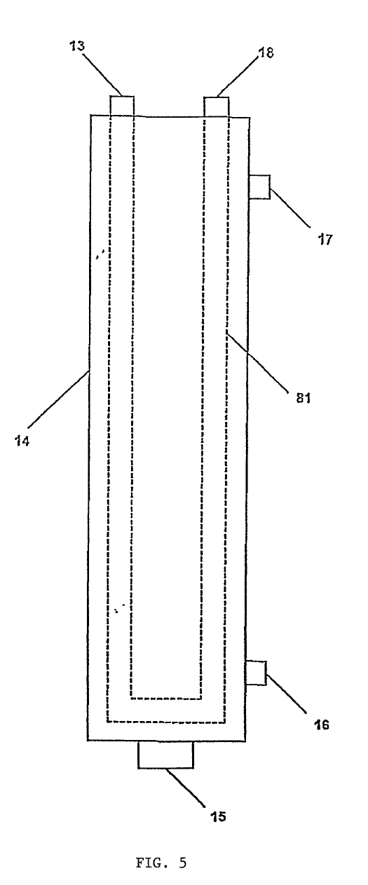

The equipment used in the multi-functional heat exchanger having a means of exchanging heat with the multiple heat source boiler, a means of exchanger heat with the single vessel heat integrated multi-stage water-gas shift reactor, and a means of receiving heat from an electrical device are illustrated in FIG. 5, which is one embodiment of the present invention. The exit stream from the fixed bed of the high temperature water-gas shift catalyst in the single vessel heat integrated multi-stage water-gas shift reactor enters the multi-functional heat exchanger 14 through inlet means 13 passes through heat exchange tube 81 and exits through exit means 18. The re-circulated water from the multiple heat source boiler enters through inlet means 16 passes through the shell side of the tubes in multi-functional heat exchanger 14 and exits through exit means 17 as a water-vapor mixture to return to the multiple heat source boiler. The third means of providing heat to the multi-functional heat exchanger 14 is from an electrical heating device such as an immersion electrical heater that is connected to the multi-functional heat exchanger 14 through connection 15.

Description of the Preferred Embodiment

In a preferred embodiment the multi-functional heat exchanger was fabricated from 3 inch 304 stainless steel schedule 40 piping having a length of 16 inches. 304 stainless steel piping, in the form of a U enters and leaves the top of the vessel. This piping is connected to the water-gas shift reaction vessel. 1/2 inch fine National Pipe Thread fittings are used on the side of the heat exchanger to make connections with the water recirculated to and from the multiple heat source boiler. A 1 inch fine National Pipe Thread connection at the bottom of the vessel is used to connect the electrical immersion water heater.

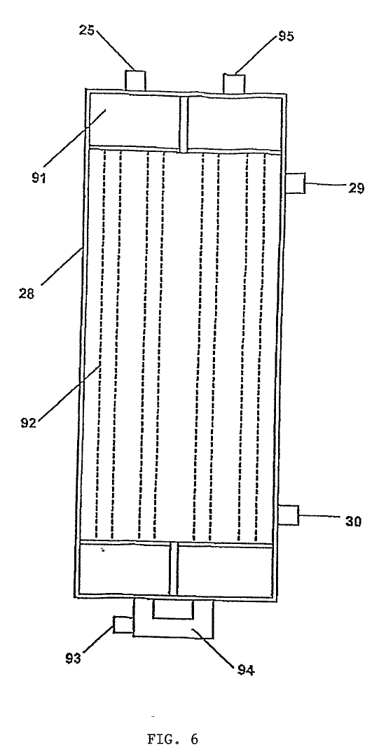

The equipment used in the single vessel water exchanged multi-staged preferential oxidation reactor is illustrated in FIG. 6, which is one embodiment of the present invention. The diagram in FIG. 6 shows an embodiment that is a preferential oxidation reactor of two stages. The product process gas mixed with air enters a first stage through inlet means 25, and flows through a first bank of parallel tubes, 92, each of which contains a fixed bed of preferential oxidation catalyst. The exit gas from said first stage is combined with an additional amount of air entering through inlet means 93 to form a feed mixture to a second stage 94, of the single vessel water heat exchanged multi-stage preferential oxidation reactor 28, which is comprised of a second bank of parallel tubes each of which contains a fixed bed of preferential oxidation catalyst. The water used to maintain the appropriate controlled temperature within the single vessel water heat exchanged multi-stage preferential oxidation reactor, and particularly to remove the exothermic heat of the preferential oxidation reactor enters at inlet means 29 and exits at outlet means 30. The water for maintaining the appropriate temperature is typically the cooling water that has exited from the fuel cell stack. The carbon monoxide content of the product process gas entering at inlet means 25 is typically 0.3 to 1.0 percent whereas the carbon monoxide content of the hydrogen containing fuel cell stack feedstock exiting at exit means 95 is typically less than 10 parts per million.

Description of the Preferred Embodiment

In a preferred embodiment the single vessel water exchanged multi-staged preferential oxidation reactor is fabricated from 5 inch 304 stainless steel schedule 40 piping, having a length of 24 inches. Tube sheets were located 3 inches from each end of the preferential oxidation reactor. Nine ⅝ inch tubes fabricated from 304 stainless steel on a ⅞ inch triangular pitch occupied one half of the cross-sectional area of the reactor and were filled with preferential oxidation catalyst to form the first stage. The inlet to the headspace for the tube sheet was a 3/4 inch fine National Pipe Thread fitting located at the top of the vessel. The outlets of the nine tubes were connected to a headspace at the bottom of the reactor from which 1/2 inch stainless steel tubing in the shape of a U formed the outlet from the first stage and the inlet to the second stage. A 1/4 inch tube was the connection used to add the second stage air to the U shaped tube connecting the first stage outlet to the second stage inlet. The second stage tubes were identical to the first stage tubes. The outlets from the nine second-stage tubes were connected to a headspace at the top of the reactor. A 3/4 inch fine National Pipe Thread fitting was the outlet from the second-stage headspace.

Although only specific embodiments of the present invention have been described, numerous variations can be made in these embodiments without departing from the spirit of the invention, and all such variations that fall within the scope of the appended claims are intended to be embraced thereby.

The foregoing disclosure of this invention is not considered to be limiting since variations can be made by those skilled in the art without departing from the scope and spirit of the appended claims.

1. A fuel processor comprised of a hydrogen generating apparatus, a single vessel heat-integrated multi-stage water-gas shift reactor, a multifunctional heat exchanger, a multiple heat source boiler, and a single vessel water heat exchanged multi-staged preferential oxidation reactor, that provides hydrogen to a fuel cell stack and that is integrated by more than one means with said fuel cell stack.

2. The fuel processor according to claim 1 wherein said hydrogen generating apparatus is comprised of a combustion chamber, a burner, a steam reformer catalytic reactor, and a heat exchanger.

3. The hydrogen generating apparatus according to claim 2 wherein said combustion chamber has sufficient volume to provide a residence time, that is for the combustion products at normal temperature and pressure in the range of 1 second to 15 seconds, preferably 2 seconds to 10 seconds.

4. The hydrogen generating apparatus according to claim 2 wherein said combustion chamber is cylindrical with a length to diameter ratio in the range of 0.5 to 4.0, preferably from 1.0 to 3.0.

5. The hydrogen generating apparatus according to claim 2 wherein said combustion chamber has a burner mounted on the sidewall of said combustion chamber.

6. The combustion chamber according to claim 5 wherein said burner is a metal fiber burner operating in a high-intensity blue flame mode releasing the major part of the energy in a convective way.

7. The metal fiber burner according to claim 6 wherein said burner is a knitted metal fiber burner.

8. The knitted metal fiber burner according to claim 7 wherein said burner operates at temperatures up to 1920° F.

9. The knitted metal fiber burner according to claim 7 wherein said burner has a heating intensity from 900 kW/m² to 5000 kW/m² and preferably from 1000 kW/m² to 3000 kW/m².

10. The knitted metal fiber burner according to claim 7 wherein the metal fibers of said burner are manufactured from a Fecralloy steel containing the following elements, iron, chromium, aluminum, yttrium, silicon, manganese, copper, and carbon.

11. The knitted metal fiber burner according to claim 7 wherein said burner operates simultaneously with more than one fuel.

12. The knitted metal fiber burner according to claim 11 wherein one of said fuels is a hydrocarbon and the other is a mixture of gases containing carbon dioxide and hydrogen.

13. The mixture of gases containing carbon dioxide and hydrogen according to claim 11 wherein said mixture is obtained by a means of integrating the fuel processor with a fuel cell stack and said mixture is the anode off-gas from said fuel cell stack.

14. The fuels according to claim 11 wherein the hydrocarbon is one of the following, liquefied petroleum gas, natural gas, or diesel fuel and the mixture is the anode off-gas from a fuel cell stack whose proportions of carbon dioxide, hydrogen, and other gases vary with the operating conditions of said fuel cell stack.

15. The combustion chamber according to claim 5 wherein said burner is comprised of a ceramic material.

16. The ceramic burner according to claim 11 wherein said burner operates at temperatures up to 2100° F.

17. The steam reformer according to claim 2 wherein the steam reforming catalyst is located within a U-shaped reaction vessel located inside combustion chamber according to claim 5.

18. The heat exchanger according to claim 2 wherein said heat exchanger is a double pipe heat exchanger transferring heat from the combustion chamber flue gas leaving the combustion chamber to the mixture of reactant gases being fed to a fixed bed of steam reforming catalyst, said heat exchanger being located at the top of the combustion chamber.

19. The fuel processor according to claim 1 wherein said single vessel heat integrated multi-staged water-gas shift reactor is comprised of two or more water-gas shift reactors, and a means of exchanging heat with a multi-functional heat exchanger.

20. The single vessel heat integrated multi-staged water-gas shift reactor according to claim 19 wherein at least one of the water-gas shift reactors within a single vessel is operated at a greater temperature and at least one other within the same vessel is operated at a lesser temperature.

21. The single vessel heat integrated multi-staged water-gas shift reactor according to claim 19 wherein the gas mixture lea vin g the water-gas shift reactor that i s operated at the greater temperature is cooled by passing through a multi-functional heat exchanger prior to entering the water-gas shift reactor that is operated at the lesser temperature, during normal operating conditions.

22. The single vessel heat integrated multi-staged water-gas shift reactor according to claim 19 wherein the gas mixture leaving the water-gas shift reactor that is operated at the greater temperature is heated by multi-functional heat exchanger prior to entering the water-gas shift reactor that is operated at the lesser temperature, during start-up conditions while the water-gas shift reactor that is operated at the lesser temperature has a temperature less than the temperature of the multiple heat source boiler of claim 1.

23. The fuel processor according to claim 1 wherein said multi-functional heat exchanger is comprised of means of receiving and providing heat to a water-gas shift catalyst bed operated at a greater temperature, a water-gas shift catalyst bed operated at a lower temperature, a multiple heat source boiler, and a means of receiving heat from an electrical device.

24. The multi-functional heat exchanger of claim 23 wherein said heat exchanger receives heat from a process gas mixture exiting a water-gas shift reactor operating a greater temperature returning said gas mixture at a lower temperature to a water-gas shift reactor operating at a lower temperature and transfers said heat to water arriving from the multiple heat source boiler of claim 1 and returning said water in the form of a water-vapor mixture to said multiple heat source boiler, during normal operation.

25. The multi-functional heat exchanger of claim 23 wherein said electrical device is an immersion water heater physically located with said multi-functional heat exchanger.

26. The multi-functional heat exchanger of claim 23 wherein said heat exchanger transfers heat generated by said electrical device to water arriving from the multiple heat source boiler of claim 1 and returning said water in the form of a water-vapor mixture to said boiler, during the initial start-up of said boiler, when the water temperature of said multiple heat source boiler is less than its boiling point.

27. The multi-functional heat exchanger of claim 23 wherein said heat exchanger transfers heat generated by said electrical device to the process gas mixture of claim 24 during the initial start-up operation when the temperature of the water-gas shift reactor operating at the lower temperature is less than the boiling point of the water in said multiple heat source boiler of claim 1.

28. The multi heat source boiler of claim 1 wherein said boiler has multiple means of simultaneously receiving heat to generate steam from boiler feed water.

29. The boiler of claim 28 wherein one of the means of receiving heat is combustion gas mixture emanating from the double pipe heat exchanger of claim 18.

30. The boiler of claim 28 wherein one of the means of receiving heat is the process gas mixture emanating from the water-gas shift catalyst bed operated at lower temperature of claim 20.

31. The boiler of claim 28 wherein one of the means of receiving heat is water-vapor mixture emanating from the multi-functional heat exchanger of claim 23.

32. The fuel processor of claim 1, wherein said single vessel water exchanged multi-staged preferential oxidation reactor is comprised of multiple stages and each stage is comprised of parallel tubular reactors filled with fixed beds of preferential oxidation catalyst, means of adding air to each fixed bed of catalyst, and means of maintaining the appropriate reactor temperature including means of removing the exothermic heat of the preferential oxidation reaction, all being arranged in a shell and rube geometries.

33. The preferential oxidation reactor of claim 32 wherein at least two stages of fixed beds of catalyst are used.

34. The preferential oxidation reactor of claim 33 wherein the total amount of air is divided among the two stages in a proportion having a range from 90:10 to 30:70 and preferably from 80:20 to 40:60, where the first figure is the proportion that enters the first fixed bed and the second figure is the proportion that enters the second fixed bed.

35. The preferential oxidation reactor of claim 32 wherein said means of maintaining the temperature of said reactor is a stream of water that is at the appropriate temperature.

36. The preferential oxidation reactor of claim 35 wherein said stream of water is obtained by a means of integrating the fuel processor with the fuel cell stack, more particularly it is the cooling water from a fuel cell stack that has been integrated with the fuel processing apparatus of claim 1.

37. The preferential oxidation reactor of claim 32 wherein said stream of water is passed over the shell side of the tubular reactors within the various stages of said preferential oxidation reactor.

38. The preferential oxidation reactor of claim 36 wherein said water stream exchanges heat initially with the first stage tubular reactors having fixed beds of catalyst and later with the last stage of tubular reactors having fixed beds of catalyst.

39. The preferential oxidation reactor of claim 36 wherein said water stream exchanges heat initially with the last stage of tubular reactors having fixed beds of catalyst and later with the first stage of tubular reactors having fixed beds of catalyst.
